(19) United States
(12) Patent Application Publication
(10) Pub. No.: US 2026/0148537 A1
(43) Pub. Date: May 28, 2026

(54) ELECTRONIC APPARATUS, METHOD, RECORDING MEDIUM FOR GENERATING ADVERSARIAL PATCH

(71) Applicant: Foundation of Soongsil University-Industry Cooperation, Seoul (KR)

(72) Inventors: Daeseon Choi, Daejeon (KR); Hyunsik Na, Seoul (KR); Wonho Lee, Seoul (KR); Seungdeok Roh, Seoul (KR); Sohee Park, Seoul (KR)

(21) Appl. No.: 19/218,242

(22) Filed: May 24, 2025

(30) Foreign Application Priority Data
Nov. 26, 2024 (KR) 10-2024-0170641

(51) Int. Cl. G06V 10/776; G06V 10/25; G06V 10/74; G06V 10/764; G06V 10/82

(52) U.S. Cl. CPC G06V 10/776; G06V 10/25; G06V 10/761; G06V 10/764; G06V 10/82

(57) ABSTRACT

The present disclosure may include: determining at least one of a size, a position, and an angle of an adversarial patch displayed in an image; inputting an image including a target object and the adversarial patch into a model for object recognition to obtain a first probability that is an object recognition rate and a second probability that the adversarial patch is classified as the target object; and updating the adversarial patch using a loss function defined based on at least one of the first probability, the second probability, and the similarity between the target object and the adversarial patch.

### CROSS-REFERENCE TO RELATED PATENT APPLICATION

This application claims the benefit of Korean Patent Application No. 10-2024-0170641, filed on Nov. 26, 2024, in the Korean Intellectual Property Office, the disclosure of which is incorporated herein in its entirety by reference.

### TECHNICAL FIELD

The present disclosure relates to an electronic apparatus, method, and recording medium for generating an adversarial patch.

### BACKGROUND

With the development of artificial intelligence and a machine learning model, image processing technology is rapidly developing. The image processing technology is widely used in various fields such as an autonomous vehicle, facial recognition, a surveillance system, and medical image analysis.

However, the machine learning model used in the field of image processing technology are likely to be intentionally confused by malicious attacks. One of such attacks is an “adversarial patch”. The adversarial patch refers to a pattern or image that is designed to a part of an image or object and is designed to distort or confuse the recognition performance of the machine learning model. Even when the adversarial patch is applied to only a small portion of an existing image, it may significantly change prediction results of the entire image. For example, by adding the adversarial patch to a specific portion of an image, the machine learning model may incorrectly recognize or fail to recognize the object. Therefore, various techniques related to the adversarial patch are being studied.

### SUMMARY

### Technical Problem

The present disclosure is directed to generating an adversarial patch that causes a model to recognize the adversarial patch as a target object in an image.

The present disclosure is directed to updating the adversarial patch by defining a loss function based on a first probability that is an object recognition rate obtained from a model and a second probability that is a probability of a case in which the adversarial patch is classified as the target object.

The present disclosure is directed to updating the adversarial patch by defining a loss function based on a similarity between a histogram of the adversarial patch and a histogram of the target object.

The present disclosure is directed to generating an evaluation index according to an attack type of the adversarial patch.

Aspects to be solved by the present disclosure are not limited to the aspects mentioned above, and other aspects not mentioned will be clearly understood by those skilled in the art from the following description.

### Technical Solution

In one embodiment, the method may include: determining at least one of a size, a position, or an angle of an adversarial patch displayed in an image; inputting an image including a target object and the adversarial patch into a model for object recognition to obtain a first probability that is an object recognition rate and a second probability that is a probability that the adversarial patch is classified as the target object; and updating the adversarial patch using a loss function defined based on at least one of the first probability, the second probability, and a similarity between the target object and the adversarial patch.

In one embodiment, the determining of at least one of the size, the position, and the angle of the adversarial patch may include: setting a first region in the image; determining a size of a region which is smaller than the first region in the image as the size of the adversarial patch; and determining at least one of the position or the angle of the adversarial patch based on a center of the first region.

In one embodiment, the updating of the adversarial patch may include updating the adversarial patch to reduce the defined loss function in a state in which parameters included in the model are fixed.

In one embodiment, the loss function may be determined based on a first loss function determined based on at least one of the first probability and the second probability and a second loss function determined based on the similarity between a histogram of the target object and a histogram of the adversarial patch.

In one embodiment, the updating of the adversarial patch includes: determining one loss function of a plurality of candidate loss functions based on a generation goal of the adversarial patch; updating the adversarial patch based on the determined loss function, wherein the generation goal of the adversarial patch may include at least one of a first goal of classifying the adversarial patch as the target object, a second goal of classifying the adversarial patch displayed to overlap the target object included in the image as the target object, and a third goal of classifying the adversarial patch displayed to overlap the target object included in the image as an object different from the target object.

In one embodiment, the method may further include determining the first loss function based on a value obtained by multiplying the first probability and the second probability and a reference value according to a determination that the generation goal of the adversarial patch is the first goal.

In one embodiment, the first loss function may be determined based on a difference between the value obtained by multiplying the first probability and the second probability and the reference value.

In one embodiment, the method may further include determining the first loss function based on at least one of the first probability, the second probability, and a third probability indicating the classification result according to a determination that the generation goal of the adversarial patch is the second goal or the third goal.

In another embodiment, a computer-readable recording medium recording a program for generating an adversarial patch, the program may determine at least one of a size, a position, and an angle of the adversarial patch displayed in an image; input an image including a target object and the adversarial patch into a model for object recognition to obtain a first probability that is an object recognition rate and a second probability that is a probability of a case in which the adversarial patch is classified as the target object, and update the adversarial patch using a loss function defined based on at least one of the first probability, the second probability, and a similarity between the target object and the adversarial patch.

In another embodiment, an electronic apparatus may include: a memory; and one or more processors, wherein the processor determines at least one of a size, a position, and an angle of an adversarial patch displayed in an image, inputs an image including a target object and the adversarial patch into a model for object recognition to obtain a first probability that is an object recognition rate and a second probability that is a probability that the adversarial patch is classified as the target object, and updates the adversarial patch using a loss function defined based on at least one of the first probability, the second probability, or a similarity between the target object and the adversarial patch.

### Advantageous Effects

The present disclosure can generate an adversarial patch that causes a model to recognize an adversarial patch as a target object in an image.

The present disclosure can update the adversarial patch by defining a loss function based on a first probability that is an object recognition rate obtained from a model and a second probability that is a probability of a case in which the adversarial patch is classified as the target object.

The present disclosure can update the adversarial patch by defining a loss function based on a similarity between a histogram of the adversarial patch and a histogram of the target object.

The present disclosure can generate an evaluation index according to an attack type of the adversarial patch.

Effects according to the present disclosure are not limited to the effects described above, and other effects not mentioned will be clearly understood by those skilled in the art from the following description.

### BRIEF DESCRIPTION OF THE DRAWINGS

FIG. 1 is a view illustrating a method of generating an adversarial patch according to an embodiment of the present disclosure.

FIG. 2 is a view illustrating a method of determining a size, a position, and an angle of an adversarial patch according to a creating attack type according to an embodiment of the present disclosure.

FIG. 3 is a view illustrating a method of determining a position and an angle of an adversarial patch according to a hiding attack or a substitute attack type according to an embodiment of the present disclosure.

FIG. 4 is a view illustrating a method of determining a similarity according to an embodiment of the present disclosure.

FIG. 5 is a view illustrating an electronic apparatus according to an embodiment of the present disclosure.

FIG. 6 is a flowchart illustrating a method of generating an adversarial patch by an electronic apparatus according to an embodiment of the present disclosure.

### DETAILED DESCRIPTION OF THE EMBODIMENTS

Hereinafter, exemplary embodiments according to the present disclosure will be described in detail with reference to the contents described in the accompanying drawings. However, the present disclosure is not limited or restricted by the exemplary embodiments. Unless otherwise defined, all terms (including technical and scientific terms) used in this specification will be used with a meaning that can be commonly understood by those skilled in the art to which the present disclosure belongs, but the terms may vary depending on the intention or customs of those skilled in the art, the emergence of new technologies, etc.

In addition, terms defined in commonly used dictionaries are not to be interpreted ideally or excessively unless explicitly specifically defined. In certain cases, there are terms that the applicant has arbitrarily selected, and in this case, the meaning thereof will be described in detail in the relevant description section. Therefore, in the present disclosure should be defined based on the meaning of the term and the overall content of the present disclosure, rather than simply the name of the term.

Throughout this specification, when a certain part “includes” a certain component, this does not exclude other components from being included unless described otherwise, and other components may in fact be included. Furthermore, the singular forms used herein also include plural forms unless specifically stated otherwise. Furthermore, the expression “at least one of a, b, and/or c” used throughout this specification can encompass “a alone,” “b alone,” “c alone,” “a and b,” “a and c,” “b and c,” or “all of a, b, and c”.

Meanwhile, terms such as “first and/or second” used in this specification may be used to describe various components, but the terms are only used for the purpose of distinguishing one component from another component, and is not intended to be limited to the component referred to by the terms. For example, without departing from the scope of the rights of the present disclosure, a first component may be referred to as a second component, and the second component may also be referred to as the first component.

In addition, terms such as “ . . . unit”, “ . . . module”, etc. described in this specification refer to a unit of processing at least one function or operation, and may be implemented by hardware or software or a combination thereof. In addition, embodiments of the present disclosure in this specification may be represented by functional block configurations and various processing steps. These functional blocks may be implemented by various numbers of hardware or/and software configurations that execute specific functions. For example, embodiments of the present disclosure may employ direct circuit configurations such as memory, processing, logic, look-up tables, etc. that may execute various functions under the control of one or more microprocessors or other control devices.

In an embodiment according to the present disclosure, a function related to artificial intelligence may be implemented through a processor and a memory. In this case, the processor may be any one of a general-purpose processor such as a center processing unit (CPU), an application processor (AP), a digital signal processor (DSP), a graphic-only processor such as a graphics processing unit (GPU), a vision processing unit (VPU), and an artificial intelligence-only processor such as a neural network processing Unit (NPU). The processor may process input data according to a predefined operation rule or an artificial intelligence model stored in the memory. Alternatively, when the processor is the artificial intelligence-only processor, the artificial intelligence-only processor may be designed with a hardware structure specialized for processing a specific artificial intelligence model. In some embodiments according to the present disclosure, the function related to artificial intelligence may be implemented through a plurality of processors.

In an embodiment according to the present disclosure, a predefined operation rule or an artificial intelligence model may be configured to perform machine learning. Here, being configured to perform machine learning means that the predefined operation rule or the artificial intelligence model is configured to perform a desired characteristic (or purpose) by training using a plurality of learning data based on a learning algorithm. Such learning may be performed in the device itself in which the artificial intelligence according to the present disclosure is implemented, or may be performed through a separate server and/or system.

The artificial intelligence model may be implemented as a neural network (or an artificial neural network), and may operate based on a statistical learning algorithm that imitates biological nerves in machine learning and cognitive science. A neural network may mean a model in which artificial neurons (nodes) that form a network by combining synapses change the strength of the synapses through learning and have problem-solving capabilities in general. A neural network may consist of a plurality of neural network layers, and an example, a neural network may include an input layer, a hidden layer, and an output layer. Each of the plurality of neural network layers may include at least one node and at least one weight, and may perform a neural network operation through an operation between an operation result of a previous layer and a weight. At least one weight of the plurality of neural network layers may be optimized by a training result of the artificial intelligence model. For example, at least one weight may be updated so that a loss value or cost value obtained from the artificial intelligence model is reduced or minimized during a training process. The neural network may infer a result to be predicted from arbitrary input.

The learning method of an artificial intelligence model may be divided into supervised learning, in which input data and output data are provided as training data, so that the correct answer (output data) corresponding to the problem (input data) is determined, unsupervised learning, in which only input data is provided without output data, so that the correct answer (output data) corresponding to the problem (input data) is not determined, and reinforcement learning, in which a reward is given whenever an action is taken in the current state, and learning is performed in the direction of maximizing this reward. Alternatively, it may be divided according to the architecture, which is a structure of the learning model.

In an embodiment of the present disclosure, the artificial intelligence model may use at least one of various artificial intelligence structures and algorithms such as Convolution Neural Network (CNN) such as GoogleNet, AlexNet, VGG Network, Region with Convolution Neural Network (R-CNN), Region Proposal Network (RPN), Recurrent Neural Network (RNN), Stacking-based deep Neural Network (S-DNN), State-Space Dynamic Neural Network (S-SDNN), Deconvolution Network, Deep Belief Network (DBN), Restrcted Boltzman Machine (RBM), Fully Convolutional Network, Long Short-Term Memory (LSTM) Network, Classification Network, Generative Modeling, explainable AI, Continual AI, Representation Learning, AI for Material Design, BERT, SP-BERT, MRC/QA, Text Analysis, Dialog System, GPT-3, GPT-4 for natural language processing, Visual Analytics for vision processing, Visual Understanding, Video Synthesis, ResNet for data intelligence, Anomaly Detection, Prediction, Time-Series Forecasting, Optimization, at least one of various artificial intelligence structures and algorithms such as Recommendation, Data Creation, etc., and the above-described examples are merely listing examples of artificial intelligence structures and algorithms used according to embodiments of the present disclosure, and do not limit the artificial intelligence structures and algorithms used according to embodiments of the present disclosure.

Hereinafter, various embodiments of the present disclosure will be described in detail with reference to the accompanying drawings. In describing the embodiments, descriptions of technical contents that are well known in the art to which the present disclosure belongs and are not directly related to the present disclosure will be omitted. This serves to convey the gist of the present disclosure more clearly by omitting unnecessary descriptions. For the same reason, some components in the accompanying drawings are exaggerated, omitted, or schematically illustrated. In addition, the size of each component does not fully match the actual size thereof. Throughout this specification, like reference numerals may refer to like or corresponding components.

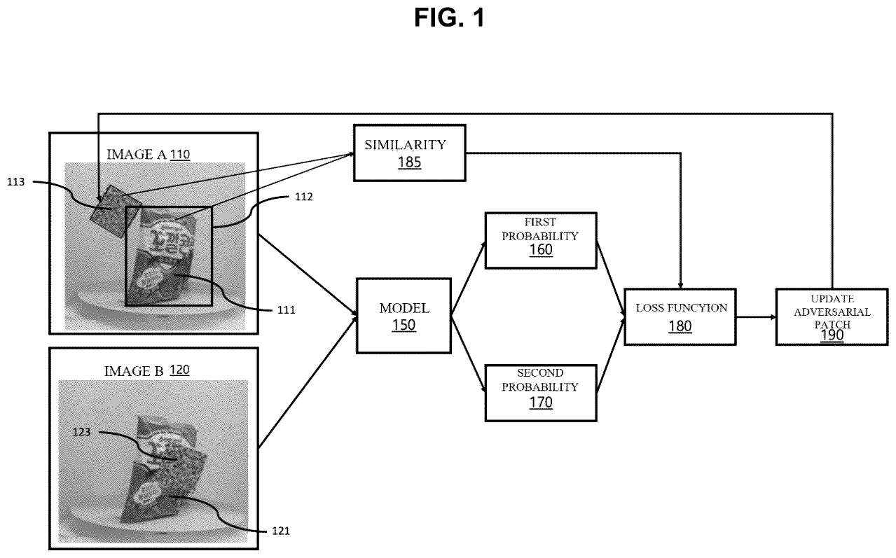

FIG. 1 is a view illustrating a method of generating an adversarial patch according to an embodiment of the present disclosure.

Neural networks may easily misclassify even small deformations due to excessive linearity, and these characteristics may be used to perform invisible attacks. The adversarial patch is designed to be visually identifiable for attacks in a physical environment and induces malfunctions in neural networks. There are studies on loss functions and printable conditions for the adversarial patch to enhance the concealment of the adversarial patch and their effectiveness in the physical environment.

The adversarial patch may pose a threat to object detection models. The adversarial patch can increase the attack difficulty in object detection models such as YOLO or Faster R-CNN compared to classification models. Therefore, a method of simultaneously attacking bounding box recognition and object classification may be used in order for an adversarial patch attack to succeed in YOLO or Faster R-CNN. For example, an attack may be used in which YOLO or Faster R-CNN generates a bounding box for the adversarial patch and generates a classification result that the adversarial patch corresponds to a specific object.

Research related to adversarial detection may be performed in various environments such as person detection, traffic surveillance, and drone video. Furthermore, security analysis in automated retail environments such as unmanned stores may also be possible.

The present disclosure is directed to analyzing the practical impact of attacks through the adversarial patch in a physical test space targeting a real-time object detection model, including various attack types related to the adversarial patch.

A model 150 of the present disclosure may be learned to perform object detection. The model 150 may be a neural network, for example, YOLO or Faster R-CNN. Specifically, YOLO divides an input image into a plurality of grids and predicts bounding box for objects included in the image. After that, the object class probability of each bounding box is predicted through the Non-Maximum Suppression (NMS) algorithm. YOLO may output a first probability 160 that is the object recognition rate (probability corresponding to the bounding box) and a third probability that is the probability of a case in which the adversarial patch is classified as a specific object (or class).

In the faster R-CNN, the input image passes through a convolutional neural network and region of interest (ROI) pooling, and a size-adjusted feature map is extracted. After that, the feature map is input to a classifier that outputs the probability of being classified into a class (or object) to obtain the third probability, and the feature map is input to a regressor that outputs the object recognition rate to obtain the first probability, and a value obtained by multiplying the final first probability and the third probability may be obtained through a non-maximum suppression algorithm.

The third probability may represent the probability that an object within a bounding box is a specific class. For example, a class may refer to an object name. For example, a class may indicate a product name such as snack A, snack B, drink A, flour, milk, etc. A target object may be an object that is a target of an adversarial patch attack. For example, when snack A is the target of an attack, the target object may be snack A.

A second probability 170 may represent the probability that an object within the bounding box is the target object. For example, when the target object is snack A, the second probability 170 may indicate the probability that the object within the bounding box is the target object.

The attack type of the adversarial patch may vary depending on the generation goal of the adversarial patch. The generation goal of the adversarial patch may include a first goal of classifying the adversarial patch as the target object, a second goal of classifying the adversarial patch displayed to overlap the target object included in the image as the target object, and a third goal of classifying the adversarial patch displayed to overlap the target object included in the image as a different object from the target object.

The attack type of the adversarial patch may include a creating attack corresponding to the first goal. The creating attack may have a goal of allowing an adversarial patch to be located in all regions within a viewpoint of a camera and a target object that does not actually exist in a region where the adversarial patch is located is recognized. Therefore, the first goal is to classify the adversarial patch as the target object, and there is no constraint that the adversarial patch should be included within the bounding box including the target object.

The attack type of the adversarial patch may include a hiding attack corresponding to the second goal and an altering attack corresponding to the third goal. The hiding attack and the altering attack may cause hidden or transformational shapes by displaying the adversarial patch overlapping the target object at the viewpoint of the camera. Therefore, the second goal (the hiding attack) may be to classify the adversarial patch displayed to overlap the target object included in the image as the target object. In the second goal, the position of the adversarial patch may be included within the bounding box of the target object. The third goal (the altering attack) may be to classify the adversarial patch displayed to overlap the target object included in the image as a different object from the target object.

Hereinafter, a method of generating an adversarial patch is described.

In one embodiment, the electronic apparatus may generate an adversarial patch using a generation model. The generation model may generate an adversarial patch based on an attack type of the adversarial patch.

In one embodiment, the electronic apparatus may determine at least one of a size, a position, or an angle of the adversarial patch displayed in image 110 and 120. The image 110 and 120 may be input to the model 150. Image A 110 may be for describing an adversarial patch corresponding to the first goal, and image B 120 may be for describing an adversarial patch corresponding to the second goal or the third goal. When the target object is a snack 111, image A 110 may include an adversarial patch 113 displayed at a certain distance from the target object. Image B 120 may include an adversarial patch 123 displayed at a position overlapping the target object 121.

In one embodiment, the electronic apparatus may input the image 110 and 120 including the target object and the adversarial patch into the model 150 for object recognition to obtain the first probability 160 that is an object recognition rate and the second probability 170 that is a probability of a case in which the adversarial patch is classified as the target object. For example, the first probability 160 may be a probability for a bounding box 112 in image A 110. The first probability 160, which is a probability for the bounding box, may indicate a probability that an object is included in the corresponding bounding box.

In one embodiment, the electronic apparatus may update the adversarial patch using a loss function defined based on at least one of the first probability 160, the second probability 170, or a similarity 185 between the target object and the adversarial patch. The similarity 185 may be a degree of similarity between the target object and the adversarial patch. For example, the similarity 185 may refer to that the target object and the adversarial patch are similar as the value is smaller, and conversely, the similarity 185 may refer to that the target object and the adversarial patch are similar as the value is larger.

In one embodiment, the electronic apparatus may update the adversarial patch to reduce a defined loss function 180 while parameters included in the model 150 are fixed. That is, the model 150 may not be updated based on the loss function 180, but may be a pre-learned model. The loss function 180 may have a goal of generating an adversarial patch that succeeds in the attack. The electronic apparatus may continuously update the adversarial patch in a direction that reduces a size of the loss function 180.

In one embodiment, the electronic apparatus may update the adversarial patch while changing at least one of the size, the position, or the angle of the adversarial patch. In addition, the electronic apparatus may generate a new adversarial patch by updating the adversarial patch based on the contrast, brightness, and/or Gaussian noise of the adversarial patch. The electronic apparatus may learn how to generate the adversarial patch in a direction that reduces the size of the loss function 180 in the process of updating the adversarial patch.

In one embodiment, the loss function 180 may be determined based on a first loss function determined based on at least one of the first probability 160 and the second probability 170 and a second loss function determined based on the similarity 185 between a histogram of the target object and a histogram of the adversarial patch.

In one embodiment, the electronic apparatus may determine one of the candidate loss functions based on the generation goal of the adversarial patch. As described above, the attack type of the adversarial patch may vary, such as a creating attack, a hiding attack, and an altering attack, and a loss function corresponding to each attack type (or goal) is different. The electronic apparatus may update the adversarial patch based on the loss function determined according to the attack type.

In one embodiment, in a case of the creating attack, the generation goal of the adversarial patch may be the first goal. The electronic apparatus may determine the first loss function based on a value obtained by multiplying the first probability 160 by the second probability 170 and a reference value according to a determination that the generation goal of the adversarial patch is the first goal. Specifically, the first loss function may be determined based on a difference between the value obtained by multiplying the first probability 160 by the second probability 170 and the reference value (e.g., 1). Accordingly, as both the first probability 160 and the second probability 170 increase, a size of the first loss function may decrease. The increase in the first probability 160 and the second probability 170 refers to that the model generates the bounding box for the adversarial patch in the image, and the probability that the object included in the bounding box is the target object is high. Therefore, updating the adversarial patch in a direction of decreasing the first loss function may refer to updating the model 150 to recognize the adversarial patch as the target object. For example, the first loss function may be expressed as [Equation 1].

$${L}_{adv} = 1 - max ( {y}_{obj} \cdot {y}_{cls}^{t} ) \qquad [ Equation 1 ]$$

L_{adv} is the first loss function of the creating attack type, y_{obj} is the first probability 160,

$${y}_{cls}^{t}$$

is the second probability 170, and 1 may refer to the reference value.

In one embodiment, according to a determination that the generation goal of the adversarial patch is the second goal or the third goal, the first loss function may be determined based on at least one of the first probability, the second probability, and the third probability indicating the classification result. The third probability may be a probability of a case in which the object included in the image is classified into a specific class. The specific class may be not only the target object but also other objects. For example, the specific class may be not only a snack that is the target object, but also cereal, beverage, coffee, ramen, etc. The second probability may be a probability of a case in which the object included in the image is the target object.

For example, according to a determination that the attack type of the adversarial patch is the hiding attack, the electronic apparatus may determine the first loss function based on the first probability and the third probability. For example, the first loss function may be affected only by the first probability, only by the third probability, or only by a value obtained by multiplying the product of the first probability and the third probability. The first loss function may decrease as the first probability and/or the third probability decrease. That is, since the goal of the hiding attack is not to identify the adversarial patch as the object by the model 150, the adversarial patch may be updated to reduce the first probability and/or the third probability. For example, the first loss function may be defined as Equation 2.

$${L}_{adv} = \{ \begin{matrix}\begin{matrix}max ( {y}_{cls} ) & if use only {y}_{cls}\end{matrix} \\ \begin{matrix}max ( {y}_{obj} ) & if use only {y}_{obj}\end{matrix} \\ \begin{matrix}max ( {y}_{obj} \cdot max ( {y}_{cls} ) ) & if use only {y}_{cls} , {y}_{obj}\end{matrix}\end{matrix} \qquad [ Equation 2 ]$$

L_{adv} is the first loss function of the hiding attack type, and y_{cls} may refer to the third probability. The reason why the second probability is not used in the hiding attack is that the result of the adversarial patch not being classified as the target object as well as any object is more important than the result of the adversarial patch being classified as the target object by the model 150. A purpose of the hiding attack is that the model 150 does not recognize the adversarial patch as the target object nor as any other object.

For example, according to the determination that the attack type of the adversarial patch is the altering attack, the electronic apparatus may determine the first loss function based on the second probability 170 and the third probability. For example, the first loss function may be determined based on a value obtained by subtracting the third probability from the reference value and a value obtained by adding the second probability. That is, the goal of the altering attack is that the target object and the other object displayed to overlap the adversarial patch by the model 150 are not identified as the other object but are identified as the target object. For example, the altering attack is that when the target object is object A, the other object is object B, and the adversarial patch is displayed to overlap object B, the model 150 may recognize object B as object A. Therefore, the adversarial patch may be updated so that the second probability 170 increases and the third probability, which is a classification result for the object other than the target object, decreases. For example, the first loss function may be defined as Equation 3.

$${L}_{adv} = max ( {y}_{cls} \vert cls \neq t ) + 2 \cdot ( 1 - {y}_{cls}^{t} ) \qquad [ Equation 3 ]$$

L_{adv} may refer to the first loss function of the altering attack type.

In one embodiment, the electronic apparatus may determine the similarity 185 based on the histogram of the target object and the histogram of the adversarial patch. The electronic apparatus may crop the bounding box including the target object from the image. The electronic apparatus may convert the image within the cropped bounding box into HSV space. HSV is one of the models for expressing color and defines color using three components of hue, saturation, and value based on the way humans perceive color. The electronic apparatus may obtain HSV histogram of the target object based on the HSV space. In addition, the electronic apparatus may convert the adversarial patch into the HSV space. In addition, the electronic apparatus may obtain the HSV histogram of the adversarial patch. The electronic apparatus may obtain the similarity 185 between the HSV histogram of the target object and the HSV histogram of the adversarial patch. For example, the electronic apparatus may determine the similarity based on the chi-square distribution between the HSV histogram of the target object and the HSV histogram of the adversarial patch. When the similarity is determined based on the chi-square distribution, a smaller value of the similarity may refer to that the target object and the adversarial patch are more similar. Therefore, a smaller similarity 185 of the present disclosure may refer to that the target object and the adversarial patch are more similar.

The second loss function is determined based on the similarity 185, and the adversarial patch is updated and generated in a direction in which the second loss function 180 decreases. The direction in which the second loss function 180 decreases may have the same meaning as the direction in which the target object and the adversarial patch become similar. Through this, the electronic apparatus may obtain the adversarial patch similar to the target object through a plurality of update processes.

In one embodiment, the second loss function is a loss function used in the creating attack and the altering attack and may not be used in the hiding attack. For example, the electronic apparatus may include the second loss function in the loss function 180 according to a determination that the attack type is one of the creating attack and the altering attack. Conversely, the electronic apparatus may not include the second loss function in the loss function 180 according to a determination that the attack type is the hiding attack.

In one embodiment, the loss function 180 may further include a third loss function and a fourth loss function in order to reduce errors that may occur during a printing process of the adversarial patch. Although the adversarial patch is generated, the adversarial patch printed in a physical space during the printing process may be different from the adversarial patch implemented digitally. To reduce such differences, the electronic apparatus may define the third loss function and the fourth loss function to update the adversarial patch. The third loss function may have a goal of maintaining consistency of the adversarial patch and smoothing the texture of the printed result. The fourth loss function may have a goal of inducing a printable color list and pixels to be as close as possible. The third loss function may be expressed by Equation 4, and the fourth loss function may be expressed by Equation 5.

$${L}_{TV} = \frac{1}{i \times j} {{Σ}_{i , j} ( {( {p}_{i , j + 1} - {p}_{i , j} )}^{2} + {( {p}_{i + 1 , j} - {p}_{i , j} )}^{2} )}^{\frac{1}{2}} \qquad [ Equation 4 ]$$

L_{TV} is the third loss function, and p refers to pixels.

$${L}_{N P S} = \frac{1}{i \times j} {Σ}_{i , j} \vert {p}_{i , j} - {c}_{print} \vert \qquad [ Equation 5 ]$$

L_{NPS} is the fourth loss function, and Cₚᵣᵢₙₜ may be a printable color list.

In one embodiment, the electronic apparatus may define the loss function 180 according to the attack type, respectively, as shown in the following Equations 6 to 8.

$${L}_{Hiding} = {λ}_{adv} \cdot {L}_{adv} + {λ}_{sal} + {λ}_{TV} \cdot {L}_{TV} + {λ}_{NPS} \cdot {L}_{NPS} \qquad [ Equation 6 ]$$

L_{adv} may be L_{adv} of Equation 2. A may be a coefficient. For example, λ may be determined as 3, 1, 1, 1 from the left.

$${L}_{Creating} = {λ}_{adv} \cdot {L}_{adv} + {λ}_{TV} \cdot {L}_{TV} + {λ}_{NPS} \cdot {L}_{NPS} + {λ}_{His} \cdot {L}_{His} \qquad [ Equation 7 ]$$

L_{adv} may be L_{adv} of Equation 1. A may be a coefficient. For example, λ may be determined as 3, 0.5, 1, 0.3 from the left. L_{His} may be the similarity 185.

$${L}_{Altering} = {λ}_{adv} \cdot {L}_{adv} + {λ}_{TV} \cdot {L}_{TV} + {λ}_{NPS} \cdot {L}_{NPS} + {λ}_{His} \cdot {L}_{His} \qquad [ Equation 8 ]$$

L_{adv} may be L_{adv} of Equation 3. A may be a coefficient. For example, λ may be determined as 3, 0.5, 1, 0.3 from the left. L_{His} may be the similarity 185.

In one embodiment, the electronic apparatus may determine an attack evaluation score of the generated adversarial patch. The electronic apparatus first captures a change in the class, which is the classification result for the object according to each attack type based on a confusion matrix, and may use a true positive rate TPR and a false positive rate FPR according to the number of objects No in the image. According to Equation 9, an evaluation score for the hiding attack type, an evaluation score for the creating attack type, and the evaluation score for the Altering Attack are exemplarily described in order.

$$\begin{matrix}Hiding Attack : {CM}_{Hiding} = 1 - ( \frac{TPR}{{N}_{O}} ) \\ Creating Attack : {CM}_{Creating} = \frac{FPR}{{N}_{O}} \\ Altering Attack : {CM}_{Altering} = ( 1 - ( \frac{TPR}{{N}_{O}} ) ) ⋂ ( \frac{FPR}{{N}_{O}} ) \\ * {N}_{O} : Number of Objects in Test Image\end{matrix} \qquad [ Equation 9 ]$$

In one embodiment, the electronic apparatus may measure how similar a size of the bounding box generated for the adversarial patch is to an original bounding box based on Complete-IoU (CIoU). Even if the adversarial patch is successful in inducing false detection of the object, when the size of the bounding box of the adversarial patch is absurdly small compared to the target object, such an attack is likely to be detected by an anomaly detection system, etc. According to Equation 10, an evaluation score for the hiding attack type, an evaluation score for the creating attack type, and an evaluation score for the altering attack are exemplarily described in order. In Equation 10, the bounding box generated for the adversarial patch may be B_{P′}, and the bounding box for the target object may be B_{GT} The evaluation score may be determined based on a size of the overlapping region of B_{P′} and B_{GT}.

$$\begin{matrix}Hiding Attack : {CIoU}_{Hiding} = 1 - ( {B}_{GT} ⋂ {B}_{P} ) \\ Creating Attack : {CIoU}_{Creating} = {B}_{GT} ⋂ {B}_{P} \\ {*}_{Assuming Random Mask Area rr} {rm}_{sB (} {B}_{GT} \\ Altering Attack : {CIoU}_{Altering} = {B}_{GT} ⋂ {B}_{P}\end{matrix} \qquad [ Equation 10 ]$$

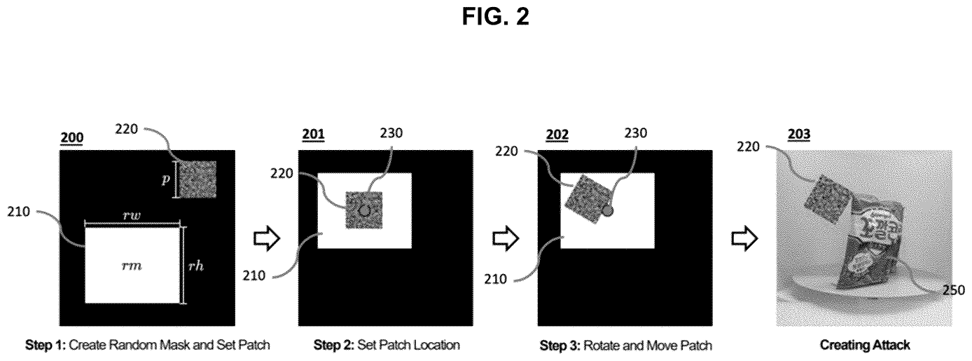

FIG. 2 is a view illustrating a method of determining a size, a position, and an angle of an adversarial patch according to a creating attack type according to an embodiment of the present disclosure.

In one embodiment, the creating attack type may correspond to the first goal. The electronic apparatus may determine the size, the position, and the angle of the adversarial patch corresponding to the first goal. The electronic apparatus may set a first region 210 in an image 200. A horizontal length rw and a vertical length rh of the first region 210 may be values obtained by multiplying the horizontal length and/or vertical length of the image 200 by a certain ratio (e.g., 0.2 to 0.7). A size of a region which is smaller than the first region 210 in the image 200 may be determined as a size of an adversarial patch 220. The size of the adversarial patch 220 may be a value obtained by multiplying a smaller value of rw and rh by a certain ratio (e.g., between 0 and 1). The adversarial patch 220 may be in a square shape, and a length of one side of the adversarial patch 220 may be a value obtained by multiplying a smaller value of rw and rh by a certain ratio (e.g., between 0 and 1).

In one embodiment, the electronic apparatus may initialize a center position of the adversarial patch 220 to be the same as a center position 230 of the first region 210 as shown in the image 201.

In one embodiment, the electronic apparatus may determine at least one of the position or the angle of the adversarial patch 220 based on the center position 230 of the first region 210. The electronic apparatus may determine the center position of the adversarial patch 220 so that the adversarial patch 220 does not deviate from the first region 210. When the adversarial patch 220 is rotated 45 degrees, the maximum distance that the adversarial patch 220 deviates from the first region 210 may be calculated. Therefore, the distance that the adversarial patch 220 extends when it rotates is as shown in the following Equation 11.

$${l}_{di ag} = {p}_{size} \times ( \sqrt{2} - 1 ) \qquad [ Equation 11 ]$$

l_{diag} is the distance extended from the image according to the rotation of the adversarial patch 220, and p_{size} may be a distance of one side of the adversarial patch 220.

Therefore, the center position of the adversarial patch may be determined within the range of the following Equations 12 and 13.

$${p}_{x}^{center} ∈ [ \frac{1}{2} \times rw + {l}_{di ag} , 1 - \frac{1}{2} \times rw - {l}_{dia g} ] \times W \qquad [ Equation 12 ]$$

$${p}_{y}^{center} ∈ [ \frac{1}{2} \times rh + {l}_{di ag} , 1 - \frac{1}{2} \times rh - {l}_{dia g} ] \times H \qquad [ Equation 12 ]$$

$${p}_{x}^{center}$$

may indicate an x-coordinate of the center position of the adversarial patch, and

$${p}_{y}^{center}$$

may indicate a y-coordinate of the center position of the adversarial patch. W and H may indicate horizontal and vertical lengths of the input image. By determining the center position of the adversarial patch 220, the position of the adversarial patch 220 may be determined.

In one embodiment, the electronic apparatus may rotate the adversarial patch 220 by a certain angle. The angle may refer to an angle at which the adversarial patch 220 is rotated based on the center position of the adversarial patch 220. By adjusting the angle, the electronic apparatus may rotate the adversarial patch 220.

The adversarial patch 220 may be displayed at various positions in the image 203 according to at least one of the size, the position, and the angle determined as described above in relation to the target object 250.

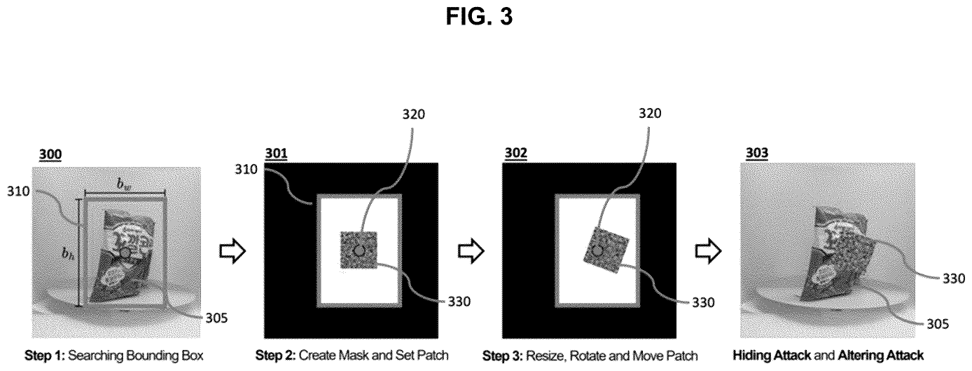

FIG. 3 is a view illustrating a method of determining a position and an angle of an adversarial patch according to a type of a hiding attack or a substitute attack according to one embodiment of the present disclosure.

In one embodiment, the electronic apparatus may generate a bounding box 310 for a target object 305 in an image 300. The electronic apparatus may generate an adversarial patch 330 within the bounding box 310 in an image 301. The electronic apparatus may arbitrarily determine a center position of the adversarial patch 330. Furthermore, a size and an angle of the adversarial patch 330 may also be arbitrarily determined. For example, the electronic apparatus may change the angle or position of the adversarial patch 330 based on a center position 320 of the bounding box 310 in an image 302. In one embodiment, the electronic apparatus may position the adversarial patch to be included in the bounding box 310 or to overlap a partial region of the bounding box 310. The adversarial patch 330 generated in an image 303 may be displayed to overlap the target object 305.

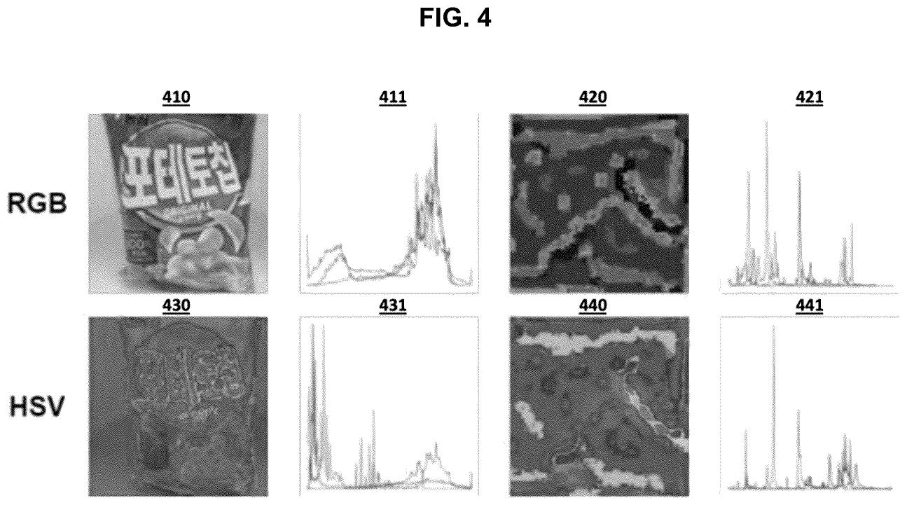

FIG. 4 is a view illustrating a method of determining similarity according to one embodiment of the present disclosure.

In one embodiment, the electronic apparatus may determine the similarity based on a chi-square distribution between HSV histogram 431 of a target object 430 and HSV histogram 441 of an adversarial patch 440.

In another embodiment, the electronic apparatus may determine the similarity based on a chi-square distribution between RGB histogram 411 of a target object 410 and RGB histogram 421 of an adversarial patch 420. RGB is one of the most widely used color models for expressing colors in digital image and display devices, and defines colors as a mixture of three primary colors: red, green, and blue.

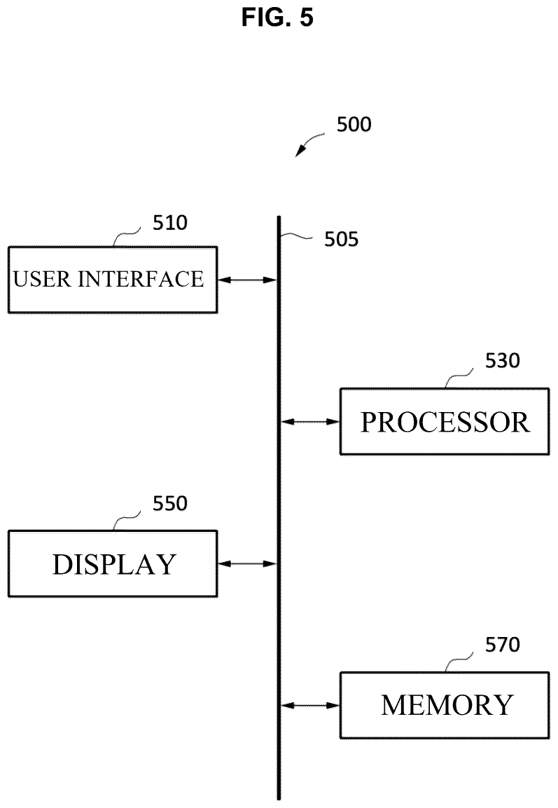

FIG. 5 is a view illustrating an electronic apparatus according to various embodiments of the present disclosure.

An electronic apparatus 500 according to an embodiment may be a server or a user terminal (e.g., a mobile device, a desktop, a laptop, a personal computer, etc.). Referring to FIG. 5, the electronic apparatus 500 according to an embodiment may include a user interface 510, a processor 530, a display 550, and a memory 570. The user interface 510, the processor 530, the display 550, and the memory 570 may be connected to each other through a communication bus 505.

The user interface 510 includes everything that enables interaction between a person and a machine. It may enable a user to manipulate and control a system, software, an application, a website, etc. For example, the user interface may include a graphical user interface, a text-based interface, a voice user interface, a natural user interface (e.g., gestures, touch, etc.), etc.

The display 550 may display information generated by the processor 530.

The memory 570 may store information generated by the processor 530. In addition, the memory 570 may store various information generated during the processing of the processor 530 described above. In addition, the memory 570 may store various data and programs. The memory 570 may include volatile memory or nonvolatile memory. The memory 570 may include a large storage medium such as a hard disk and the like to store various data.

In addition, the processor 530 may perform at least one method described above through FIGS. 1 to 4 or an algorithm corresponding to at least one method. The processor 530 may be a data processing device implemented as hardware having a circuit having a physical structure for executing desired operations. For example, the desired operations may include a code or instructions included in the program. The processor may be composed of, for example, a central processing unit (CPU), a graphics processing unit (GPU), or a neural network processing unit (NPU). For example, the electronic apparatus implemented with hardware may include a microprocessor, a central processing unit, a processor core, a multi-core processor, a multiprocessor, an application-specific Integrated circuit (ASIC), or a field programmable gate array (FPGA).

The processor 530 may execute the program and control the electronic apparatus. A program code executed by the processor 530 may be stored in the memory.

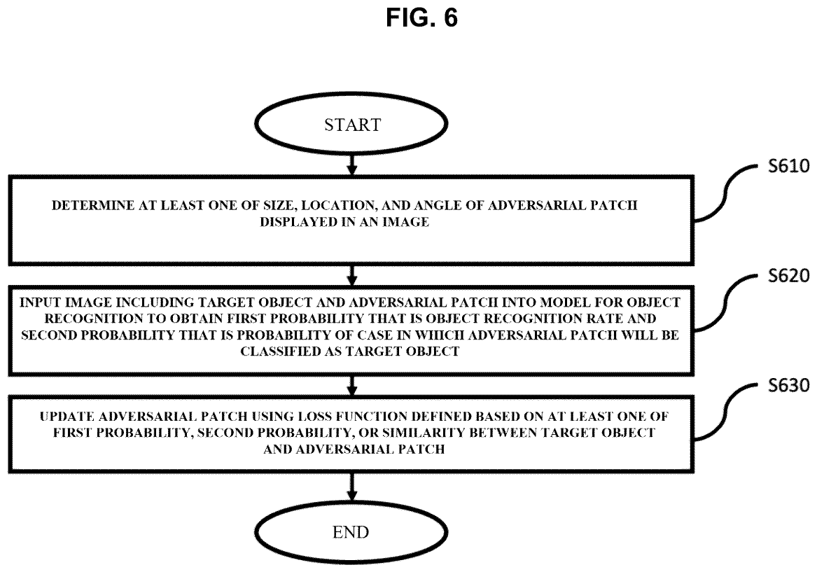

FIG. 6 is a flowchart illustrating a method of an electronic apparatus to generate an adversarial patch according to an embodiment of the present disclosure.

In one embodiment, the electronic apparatus may determine at least one of a size, a position, and an angle of an adversarial patch displayed in an image S610.

In one embodiment, the electronic apparatus may input an image including a target object and the adversarial patch into a model for object recognition to obtain a first probability that is an object recognition rate and a second probability that is a probability the adversarial patch will be classified as the target object S620.

In one embodiment, the electronic apparatus may update the adversarial patch using a loss function defined based on at least one of the first probability, the second probability, or the similarity between the target object and the adversarial patch S630.

The above-described content is a specific embodiment for implementing the present disclosure. The present disclosure will include not only the above-described embodiments but also embodiments that may be simply redesigned or easily changed. In addition, the present disclosure will also include techniques that may be easily modified and implemented using the above-described embodiments. Therefore, the scope of the present disclosure should not be limited to the above-described embodiments, but should be determined not only by the scope of the claims described later, but also by the equivalents of the claims of the present disclosure.

What is claimed is:

1. A method of generating an adversarial patch using an electronic apparatus, the method comprising:
determining at least one of a size, a position, and an angle of an adversarial patch displayed in an image;
inputting an image including a target object and the adversarial patch into a model for object recognition to obtain a first probability that is an object recognition rate and a second probability that is a probability that the adversarial patch is classified as the target object; and
updating the adversarial patch using a loss function defined based on at least one of the first probability, the second probability, and a similarity between the target object and the adversarial patch.

2. The method of claim 1,
wherein the determining of at least one of the size, the position, and the angle of the adversarial patch includes:
setting a first region in the image;
determining a size of a region which is smaller than the first region in the image as the size of the adversarial patch; and
determining at least one of the position or the angle of the adversarial patch based on a center of the first region.

3. The method of claim 1,
wherein the updating of the adversarial patch includes updating the adversarial patch to reduce the defined loss function in a state in which parameters included in the model are fixed.

4. The method of claim 1,
wherein the loss function is determined based on a first loss function determined based on at least one of the first probability and the second probability and a second loss function determined based on the similarity between a histogram of the target object and a histogram of the adversarial patch.

5. The method of claim 1,
wherein the updating of the adversarial patch includes:
determining one loss function of a plurality of candidate loss functions based on a generation goal of the adversarial patch; and
updating the adversarial patch based on the determined loss function, and
the generation goal of the adversarial patch includes at least one of
a first goal of classifying the adversarial patch as the target object,
a second goal of classifying the adversarial patch displayed to overlap the target object included in the image as the target object, and
a third goal of classifying the adversarial patch displayed to overlap the target object included in the image as an object different from the target object.

6. The method of claim 5, further comprising
determining a first loss function based on a value obtained by multiplying the first probability and the second probability and a reference value according to a determination that the generation goal of the adversarial patch is the first goal.

7. The method of claim 6,
wherein the first loss function is determined based on a difference between the value obtained by multiplying the first probability and the second probability and the reference value.

8. The method of claim 5, further comprising
determining a first loss function based on at least one of the first probability, the second probability, and a third probability indicating the classification result according to a determination that the generation goal of the adversarial patch is the second goal or the third goal.

9. A non-transitory computer-readable recording medium recording a program for generating an adversarial patch,
the program is configured to determine at least one of a size, a position, and an angle of the adversarial patch displayed in an image,
inputs an image including a target object and the adversarial patch into a model for object recognition to obtain a first probability that is an object recognition rate and a second probability that is a probability of a case in which the adversarial patch is classified as the target object, and
updates the adversarial patch using a loss function defined based on at least one of the first probability, the second probability, and a similarity between the target object and the adversarial patch.

10. An electronic apparatus comprising:
a memory; and
one or more processors,
wherein the processor determines at least one of a size, a position, and an angle of an adversarial patch displayed in an image,
inputs an image including a target object and the adversarial patch into a model for object recognition to obtain a first probability that is an object recognition rate and a second probability that is a probability that the adversarial patch is classified as the target object, and
updates the adversarial patch using a loss function defined based on at least one of the first probability, the second probability, and a similarity between the target object and the adversarial patch.
